(19) United States
(12) Patent Application Publication
(10) Pub. No.: US 2006/0182481 A1
(43) Pub. Date: Aug. 17, 2006

(54) Image recording apparatus

(75) Inventor: Kazuhiko Sugahara, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/354,852

(22) Filed: Feb. 16, 2006

(30) Foreign Application Priority Data
Feb. 17, 2005 (JP) 2005-040933

(51) Int. Cl. B41J 5/30

(52) U.S. Cl. 400/62

(57) ABSTRACT

The present invention provides an image recording apparatus having an imaging unit which shoots an image of a subject and a recording unit which records the shot image. The image recording apparatus includes: a film management unit which accepts creation of a virtual film which stores the shot image and setting of the number of images storable in the virtual film that can be shot, creates a film management information prescribing a location where an image to be stored in the virtual film is saved and the set number of images that can be shot, and manages the saving location and the set number of the images to be stored in the virtual film according to the film management information.

### BACKGROUND OF THE INVENTION

1. Field of the Invention

The present invention relates to an image recording apparatus and, more particularly, to an image recording apparatus which records image classification information.

2. Description of the Related Art

There has been conventionally devised a technique for adjusting the number of images that a user can shoot. According to, e.g., Japanese Patent Application Laid-Open No. 2002-158947, if it is determined that the remaining capacity of image memory is insufficient for next imaging operation, of images already stored in a storage device, image data not having undergone reduction processing is read out and transferred to an external device. At the same time, the image data is reduced to an extent required for display, and the reduced image data replaces the non-reduced original image data and is stored in the storage device. The technique makes it possible to shoot images not less in number than the number of images to be shot, which is a predetermined number, effectively using memory incorporated in a camera and virtually produce an effect similar to an increase in the capacity of the memory.

### SUMMARY OF THE INVENTION

In a conventional analog camera, since shooting is performed while the camera is loaded with a roll of film on which only a prescribed number of exposures can be made, it is easy to know even during shooting how many more exposures can be made. In this respect, in the technique of Japanese Patent Application Laid-Open No. 2002-158947, the remaining capacity of the memory of a digital camera is checked, and image size is reduced according to the remaining capacity, thereby increasing the number of images to be saved. Accordingly, a user can know nothing about how many more images with a non-reduced size and the same quality can be shot.

Also, in recent years, the capacity of memory for storing images is dramatically increasing. Management of the remaining capacity of memory is important, but it is even more important to easily and quickly find an image desired to be displayed or printed among a large number of images shot. In this respect, the technique of Japanese Patent Application Laid-Open No. 2002-158947 has as its object to increase the number of images to be saved and is unable to easily know what and how many images are recorded and where the images are recorded.

The present invention has been made in consideration of the above-described problems, and has as its object to make it possible to easily find a desired one among images recorded on a recording medium and easily know the number of images that can be shot.

To solve the problems, a first aspect of the present invention provides an image recording apparatus having an imaging unit which shoots an image of a subject and a recording unit which records the shot image, comprising: a film management unit which accepts creation of a virtual film which stores the shot image and setting of the number of images storable in the virtual film that can be shot, creates a film management information prescribing a location where an image to be stored in the virtual film is saved and the set number of images that can be shot, and manages the saving location and the set number of images according to the film management information.

According to the first aspect, images are managed in units of virtual “films” each capable of storing images, the number of which is the number of images that can be shot set for the virtual film. Accordingly, it is easy to search for and view a desired image.

The image recording apparatus may further comprise a display unit which displays the image.

The display unit may display the shot image stored in a virtual film for each virtual film according to the film management information.

The display unit may display the number of remaining images obtained by subtracting the number of images stored in the virtual film from the number of images that can be shot set for the virtual film.

With this configuration, a photographer can easily know how many more images can be stored in a folder corresponding to each virtual “film.”

The film management unit may calculate the number of remaining images obtained by subtracting the number of images stored in the virtual film from the number of images that can be shot set for the virtual film.

The film management unit may urge creation of a virtual film and setting of the number of images that can be shot for the virtual film if the number of remaining images reaches 0.

With these configurations, it is possible to create a state similar to one in which the number of images shot reaches the prescribed number of images that can be shot for a “film,” and the “film” needs to be replaced with another. If images are sequentially stored in virtual films, a set number of ones of the images are classified and organized into each virtual film. This is convenient for later image search, viewing, printing, and the like.

The image recording apparatus may further comprise a folder creation unit which creates a folder corresponding to the virtual film in the recording unit, a folder management unit which stores the shot image equal in number to the set number of images that can be shot in the folder, and may be configured such that a location where the shot image is saved includes a location where the folder corresponding to the virtual film is saved.

According to this invention, images equal in number to the number of images that can be shot set for the virtual film are stored in the folder. It is possible to manage, in a comprehensible manner, the numbers of images that can be recorded on virtual “films” in units of folders corresponding to “films.” Since images are managed in units of folders corresponding to films, it is easy to search for and view a desired image.

To solve the above-described problems, a second aspect of the present invention provides an image display apparatus comprising: a reading unit which reads an image recorded by the image recording apparatus according to the first aspect, from the recording unit; and a display unit which displays, for each virtual film, an image stored in the virtual film, the image read from the recording unit according to the film management information.

To solve the above-described problems, a third aspect of the present invention provides a print apparatus comprising: a reading unit which reads an image recorded by the image recording apparatus according to the first aspect, from the recording unit; a designation unit which designates a virtual film in which an image to be printed is stored for the image read from the recording unit according to the film management information; and a print unit which prints the one image stored in the designated virtual film according to the film management information.

To solve the above-described problems, a fourth aspect of the present invention provides an image recording method performed by an image recording apparatus having an imaging unit which shoots an image of a subject and a recording unit which records the shot image, the image recording method comprising: a step of accepting creation of a virtual film which stores the shot image and setting of the number of images that can be shot for the virtual film, a step of creating a film management information prescribing a location where an image to be stored in the virtual film is saved and the set number of images that can be shot, and a step of managing the saving location and the set number of images according to the film management information.

To solve the above-described problems, a fifth aspect of the present invention provides an image display method comprising: a step of reading an image recorded by the image recording method according to the fourth aspect, from the recording unit; and a step of displaying, for each virtual film, an image stored in the virtual film, the image read from the recording unit according to the film management information.

To solve the above-described problems, a sixth aspect of the present invention provides a print method, comprising: a step of reading an image recorded by the image recording method according to the fourth aspect, from the recording unit; a step of designating a virtual film in which an image to be printed is stored for the image read from the recording unit according to the film management information; and a step of printing the image stored in the designated virtual film according to the film management information.

To solve the above-described problems, a seventh aspect of the present invention provides an image recording program performed by an image recording apparatus having an imaging unit which shoots an image of a subject, a recording unit which records the shot image, and a computing unit, and causes the computing unit to perform the steps of: accepting creation of a virtual film which stores the shot image and setting of the number of images that can be shot for the virtual film; creating a film management information prescribing a location where an image to be stored in the virtual film is saved and the set number of images that can be shot; and managing the saving location and the set number of images to be stored in the virtual film according to the film management information.

According to the seventh aspect, images are managed in units of virtual “films” each capable of storing images, the number of which is the number of images that can be shot set for the virtual film. Accordingly, it is easy to search for and view a desired image.

### BRIEF DESCRIPTION OF THE DRAWINGS

FIG. 1 is a block configuration diagram of a digital camera;

FIG. 2 is a block diagram showing programs to be executed by a CPU;

FIG. 3 is a view conceptually showing folders to be created on a recording medium;

FIG. 4 is a chart for explaining the concept of management data;

FIG. 5 is a flowchart showing the flow of a shooting process;

FIG. 6 is a front view of an in-store print apparatus according to a preferred embodiment of the present invention;

FIG. 7 is a block configuration diagram of the in-store print apparatus;

FIG. 8 is a flowchart showing the flow of print order operation; and

FIG. 9 is a view illustrating a state in which images are classified and displayed according to folders.

### DETAILED DESCRIPTION OF THE PREFERRED EMBODIMENTS

Preferred embodiments of the present invention will be explained below with reference to the accompanying drawings.

### First Embodiment

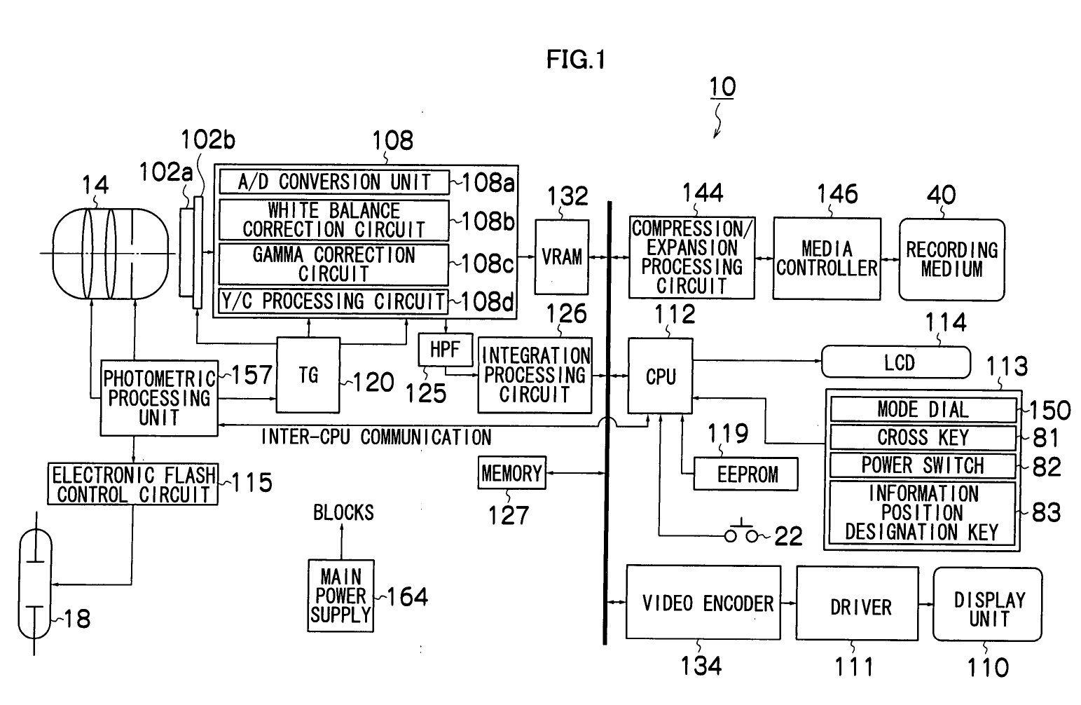

FIG. 1 is a functional block diagram of a digital camera 10 according to a preferred embodiment of the present invention. In the digital camera 10 of FIG. 1, a central processing unit (CPU) 112 controls circuits in the digital camera 10 on the basis of inputs from various buttons and keys of an operation unit 113 including a release switch 22 and mode dial 150. Programs to be executed by the CPU 112 are stored in an EEPROM 119.

When the digital camera 10 is set to a still image shooting mode with the mode dial 150, the CPU 112 displays a moving image (through image) on a display unit 110 to allow checking of a shooting view angle. More specifically, light having passed through an imaging lens 14 comes incident on a solid-state image sensor 102a. Photosensors are arranged in a planar manner on the light-receiving surface of the solid-state image sensor 102a. A subject image formed on the light-receiving surface is converted by the photosensors into signal charges corresponding to the amount of the incident light. Signal charges accumulated in this manner are sequentially read out as voltage signals (image signals) corresponding to the signal charges in response to a pulse signal supplied from a driver circuit (not shown) and applied to an imaging circuit 102b.

The imaging circuit 102b includes a gain adjustment circuit, and image data obtained through the imaging circuit 102b is sent to an image processing circuit 108 and then to a high-pass filter (HPF) 125. The image processing circuit 108 is an image processing unit which includes a white balance correction circuit 108b, a gamma correction circuit 108c, a Y/C processing circuit 108d, a luminance/color-difference signal generation circuit, a sharpness correction circuit, a contrast correction circuit, an edge processing unit which performs image processing including edge correction for a shot image, a noise reduction processing unit which performs noise reduction processing for an image, and the like. The image processing circuit 108 processes an image signal in accordance with a command from the CPU 112.

Image data input to the image processing circuit 108 is converted into a luminance signal (Y signal) and color-difference signals (Cr and Cb-signals), subjected to predetermined processing such as gamma correction, and then stored in a VRAM 132.

In the meantime, the image data is converted into digital signals in an A/D conversion unit 108a, and only G pixel components are extracted by the high-pass filter (HPF) 125. The extracted G pixel components are subjected to integration processing in an integration processing unit 126 and sent to the CPU 112. The CPU 112 calculates the average value of pieces of image data for four areas near the center of a face arbitrarily selected among pieces of image data for 64 areas, into which one screen is divided, sent from the integration processing unit 126 and sets the value as an autofocus (AF) evaluation value. The center of the face is set by a face detection unit. The AF evaluation value is calculated after each lapse of a predetermined period and is updated and stored in a memory 127 after each calculation. As will be described later, an in-focus determination unit which is a program to be executed by the CPU 112 determines according to the AF evaluation value whether a human face area is in focus.

When outputting a shot image on the display unit 110 for monitoring, Y/C signals are read from the VRAM 132 and sent to a video encoder 134. The video encoder 134 converts the input Y/C signals into signals in a predetermined format for display (e.g., NTSC color composite video signals) and outputs them on the display unit 110. The display unit 110 is driven through a driver 111.

Y/C signals of each frame processed at a predetermined frame rate are written alternately into an A area and B area of the VRAM 132. Of the A area and B area of the VRAM 132, written Y/C signals are read out from the area other than the area in which Y/C signals are being written. In this manner, Y/C signals in the VRAM 132 are periodically rewritten. By supplying video signals generated from such Y/C signals to the display unit 110, an image during imaging is displayed on the display unit 110 in real time. A user can check the shooting view angle using the image (through image) displayed on the display unit 110.

If the release switch 22 is pressed halfway at this time, AE and AF processing is started. When the AE/AF processing is performed, and the release switch 22 is fully pressed, shooting operation for recording starts. Image data acquired in response to the full press of the release switch 22 is converted into luminance/color-difference signals (Y/C signals) in the image processing circuit 108, subjected to predetermined processing such as gamma correction, and then stored in the VRAM 132.

After the Y/C signals stored in the VRAM 132 are compressed in a predetermined format by a compression/expansion processing circuit 144, they are recorded on a recording medium 40 through a media controller 146 as an Exif (Exchangeable Image File Format) file. The image is recorded in the data section of the Exif file. The CPU 112 records shooting date and time information and the like in a predetermined tag (e.g., an ImageDescription tag) of the header section of the Exif file.

An electronic flash control circuit 115 which controls light emission of an electronic flash 18 composed of a xenon tube is also connected to the CPU 112. If a low-light situation is detected, if an instruction is given with an electronic flash button to emit light, or if the digital camera 10 is set to a forcible light emission mode, in still image shooting, the electronic flash 18 is so controlled as to emit light for a short time (e.g., a short time of one second or more) at times in sync with timing signals generated by a timing generator 120.

When the camera 10 is set to a moving image shooting mode with the mode dial 150, moving image recording operation starts in response to full press operation of the release switch 22. If the release switch 22 is pressed one more time, the moving image recording operation stops. Alternatively, the recording operation may be performed while the release switch 22 is continuously pressed, and the recording may be stopped upon release of the switch 22. Moving image data is recorded in, e.g., Motion JPEG (MPEG) format on the recording medium 40.

When a playback mode is selected with the mode dial 150, data obtained by compressing the last image file (file recorded last) recorded on the recording medium 40 is read out. If the last recorded file is a still image file, the read-out compressed image data is expanded to uncompressed Y/C signals through the compression/expansion processing circuit 144 and saved in the VRAM 132. The Y/C signals saved in the VRAM 132 are applied to the video encoder 134. The video encoder 134 generates RGB color composite video signals of the NTSC mode from the input Y/C signals and outputs them to the display unit 110. With this operation, the frame image of the last frame recorded on the recording medium 40 is displayed on the display unit 110.

When a right key of a cross key 81 is pressed after that, frames are advanced in the forward direction. On the other hand, when a left key of the cross key 81 is pressed, the frames are advanced in the backward direction. An image file at the current frame position after the frame advance is read out from the recording medium 40, and the frame image is played back on the display unit 110 in the same manner as described above. If the frames are advanced in the forward direction when the frame image of the last frame is displayed, the image file of the first frame recorded on the recording medium 40 is read out, and the frame image of the first frame is played back on the display unit 110.

The display unit 110 corresponds to an LCD 114 or viewfinder incorporated in the digital camera 10, or an external display device connected to a video output terminal or the like. Note that the CPU 112 includes an OSD (on screen display) signal generation circuit and that the OSD signal generation circuit generates signals for displaying characters representing a shutter speed, an aperture value, the number of images that can be shot, a shooting date and time, a warning message, and the like or a symbol such as an icon. Signals output from the OSD signal generation circuit are mixed with image signals as needed and supplied to the LCD 114. With this operation, a composite image in which a through image or played-back image is combined with characters, icons, and the like is displayed.

The recording medium 40 is a device which holds image data obtained by shooting, and, for example, a memory card called SmartMedia is used as the recording medium 40. The form of the recording medium is not limited to this, and a PC card, CompactFlash (registered trademark), magnetic disk, optical disk, magneto-optical disk, Memory Stick, or the like may be used instead. That is, a medium which can be read and written electronically, magnetically, optically, or by a combination of some of these schemes can be used. The digital camera 10 may be so configured as to accept a plurality of media of the same type or different types. A device which stores an image file is not limited to a removable medium which can be detached from the camera main body and may be a recording medium (internal memory) incorporated in the camera.

The CPU 112 is a control circuit which controls the circuits of the camera 10. The CPU 112 controls the operation of each circuit on the basis of a signal received from the operation unit 113 including the release switch 22, the cross key 81, a power switch 82, the mode dial 150, an information position designation key 83, the electronic flash button (not shown), a zoom key, a menu/execution button, and the like. At the same time, the CPU 112 performs display control for the display unit 110, electronic flash light emission control, autofocus (AF) control, autoexposure (AE) control, and the like.

Each time the power of the camera 10 is turned on with the power switch 82, power is supplied to the circuits of the camera 10 from a main power supply 164 composed of a battery mounted in the camera body.

Image data from the image processing circuit 108 is also sent to a photometric processing unit 157. The photometric processing unit 157 is an example of a device which measures the amount of external light. The photometric processing unit 157 can be composed of a photometric value calculation unit which calculates the photometric value (EV value) for subject luminance on the basis of each input piece of image data and the charge storage time of the solid-state image sensor 102a, i.e., the shutter time of an electronic shutter. Driving of the solid-state image sensor 102a is adjusted by the photometric processing unit 157. Note that an aperture value may be changed together with the shutter time of the electronic shutter. To change the aperture value, a photometric value corresponding to the subject luminance is calculated in consideration of the aperture value. As described above, the photometric processing unit 157 detects the brightness of a subject (subject luminance) by TTL (Through The Lens) photometry using the solid-state image sensor 102a as a light-receiving sensor. The photometric processing unit 157 may be a photometric sensor composed of a phototransistor. The photometric processing unit 157 is not limited to a specific one and may be any device as long as it can perform photometry.

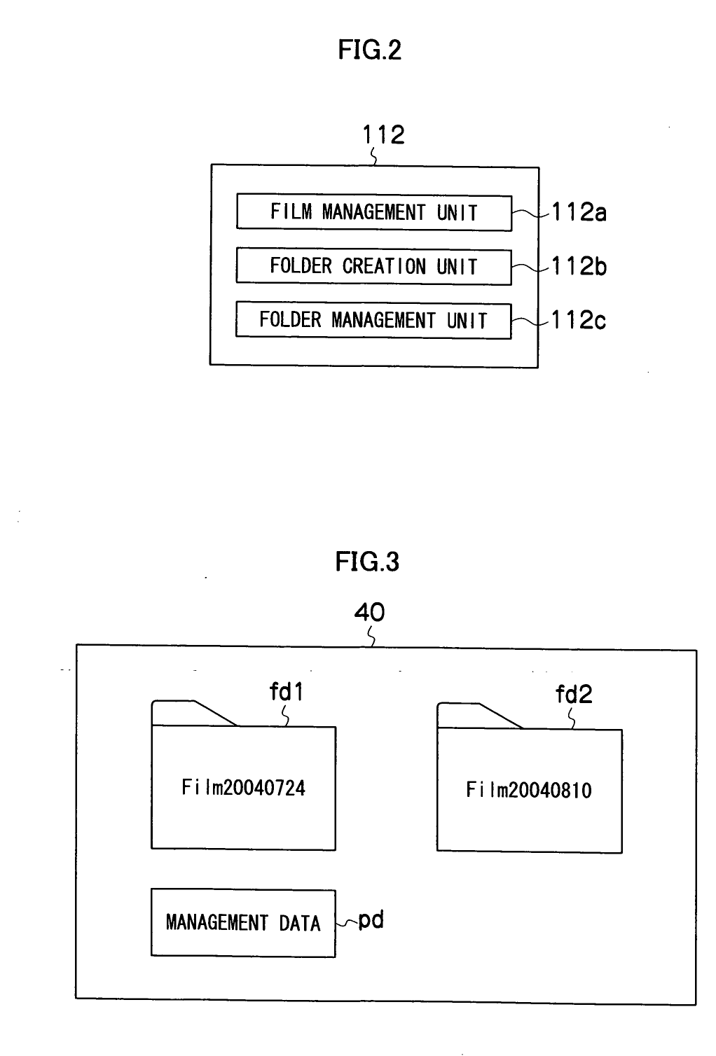

FIG. 2 shows the programs to be executed by the CPU 112 as a block diagram. The CPU 112 executes a film management unit 112a, folder creation unit 112b, and folder management unit 112c, all of which are programs. These programs are stored in the EEPROM 119 and are loaded into the memory 127 and executed as needed by the CPU 112. The film management unit 112a accepts, through user operation of the operation unit 113, creation of a virtual “film” where images, the number of which is the number of images that can be shot prescribed in advance for the virtual film, can be recorded and setting of the number of images that can be shot for the “film.” The folder creation unit 112b creates a folder corresponding to the “film” on the recording medium 40 in response to a user operation. The folder management unit 112c stores images in the folder corresponding to the “film” until the number of images to be shot set for the folder is reached.

FIG. 3 is a view for explaining the concept of folders created on the recording medium 40 by the folder creation unit 112b. A folder to which a “film” name arbitrarily input by user operation of the operation unit 113 is assigned as a folder name is created on the recording medium 40. In FIG. 3, folders fd1 and fd2 corresponding to two films “Film20040724” and “Film20040810” are created as examples. Management data pd for managing a location where each folder is created and the number of images that can be stored (to be referred to as the number of images that can be shot) in the folder is recorded on the recording medium 40.

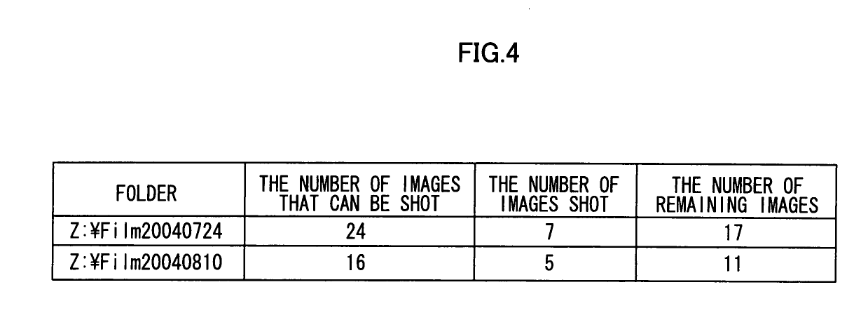

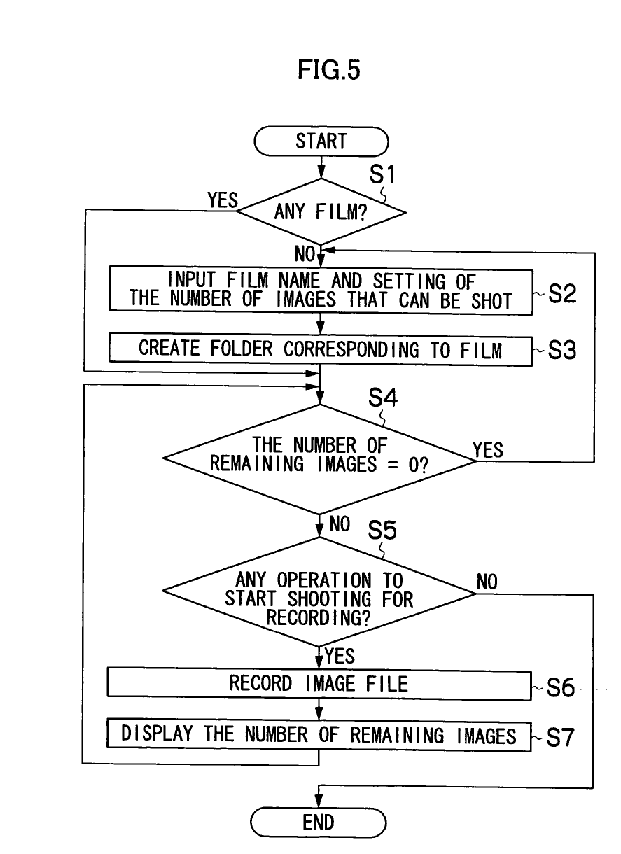

FIG. 4 conceptually shows the contents of the management data. The management data includes the location where each folder is created and has a record of the number of images that can be stored in each folder as the number of images that can be shot. The management data may include additional information such as the shooting date, title, and shooting location of each image. Alternatively, the management data may include the number of images shot, which is the number of images already stored in each folder, and the number of remaining images obtained by subtracting the number of images shot from the number of images that can be shot. The management data is created and updated by the folder management unit 112c.

FIG. 5 is a flowchart showing the flow of a shooting process to be executed by the CPU 112. In this process, a folder corresponding to a“film” is created on the recording medium 40 in response to user operation, and images obtained by imaging are sequentially stored in the folder corresponding to the “film” until the number of images that can be shot prescribed for the folder is reached. After the storage of the images, how many more images can be stored in the folder corresponding to the “film” is displayed as the number of remaining images for the “film.” This process starts when the digital camera 10 is set to the still image shooting mode with the mode dial 150.

In S1, the folder management unit 112c determines whether there is any folder on the recording medium 40. If there is any folder, the flow shifts to S4; otherwise, the flow shifts to S2.

In S2, the film management unit 112a displays, on the LCD 114, a message indicating that there is no virtual “film” and urging creation of a new film. Then, the film management unit 112a waits for the name of a film to be newly created and the setting of the number of images that can be shot for the film to be input from the operation unit 113. When the number of images that can be shot, which is a desired number, is set and input from the operation unit 113, the folder management unit 112c records, on the recording medium 40, management data obtained by associating an input film name with the number of images that can be shot for the film. Note that the film name is a unique character string. If characters representing a shooting scene are added to each film name, a corresponding shooting scene can be recalled just by looking at a folder name, and it becomes easy to search for each image.

In S3, the folder creation unit 112b creates a folder to which the input film name is assigned as a folder name on the recording medium 40.

In S4, the folder management unit 112c calculates the number of remaining images for the film by subtracting the number of images shot from the number of images that can be shot. Then, the folder management unit 112c determines whether the calculated number of remaining images is 0. If the number of remaining images is 0, the flow returns to S2 to urge creation of a new folder. On the other hand, if the number of remaining images is not 0, the flow advances to S5.

In S5, the folder management unit 112c determines whether an instruction to start shooting operation for recording is given by fully pressing the release switch 22. If an instruction to start the shooting operation for recording is given, the flow advances to S6. On the other hand, if no instruction to start the shooting operation for recording is given, an instruction to start the shooting operation is further waited for. If the still image shooting mode is canceled while waiting for this type of instruction, the shooting process ends.

In S6, the folder management unit 112c stores an image file obtained by the shooting operation for recording in the folder created in S3.

In S7, the folder management unit 112c calculates the number of remaining images by subtracting the number of images shot from the number of images that can be shot for the folder in which the image file is recorded. Then, the calculated number of remaining images is displayed on the LCD 114 or display unit 110, and the flow returns to S4.

As described above, in the camera 10 of the present invention, images are sequentially stored in a folder corresponding to a “film” until the number of images that can be shot is reached. Accordingly, the number of images that can be stored in each folder is easily known. Also, since images are managed in units of folders, it is easy to search for and view an image.

In this shooting process, it is impossible to create a new folder until the number of images stored in the folder created in S3 reaches the set number. However, the process may instead be allowed to create a plurality of folders, for each of which the number of remaining images is not 0, and arbitrarily designate a folder in which obtained images are to be stored from the operation unit 113.

### Second Embodiment

A case is also included in the present invention where images recorded in folders according to the first embodiment are classified and displayed according to the folders. A case is further included in the present invention where images recorded in a desired folder are collectively printed by designating the folder.

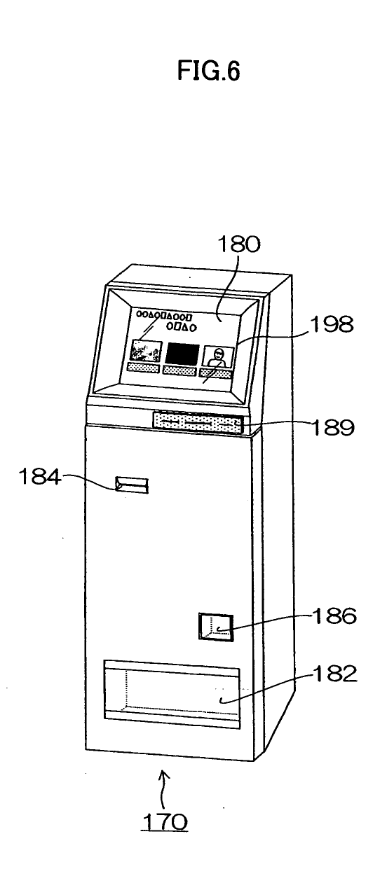

FIG. 6 is a front view of an in-store print apparatus 170 according to the present invention. The in-store print apparatus 170 is a machine which, when a customer inserts a recording medium 40 into an insertion slot 189 and drops in money, prints an image stored in the recording medium 40 on a printing medium such as TA paper. The print apparatus 170 is an in-store information terminal placed in various stores such as a photo lab, bookstore, and supermarket. Usually, a customer who wants to buy a print uses the print apparatus 170 alone, without the assistance of a clerk.

A liquid crystal type display device 180 on which a touch panel 198 is stacked is disposed on the front of the in-store print apparatus 170. A customer operates the touch panel 198 while viewing the display device 180. The customer selects an image to be printed and inputs necessary information such as print size and the number of prints. One or a plurality of printers (not shown) are set in the in-store print apparatus 170, and each printer prints an image. Up to four printers are disposed in the in-store print apparatus 170 of the second embodiment. A discharge opening 182 through which a printed printing medium is discharged, a drop slot 184 through which a coin is dropped into a coin machine 188 (to be described later), and a return slot 186 to which the coin machine 188 returns change are formed in the outside of the front of the in-store print apparatus 170.

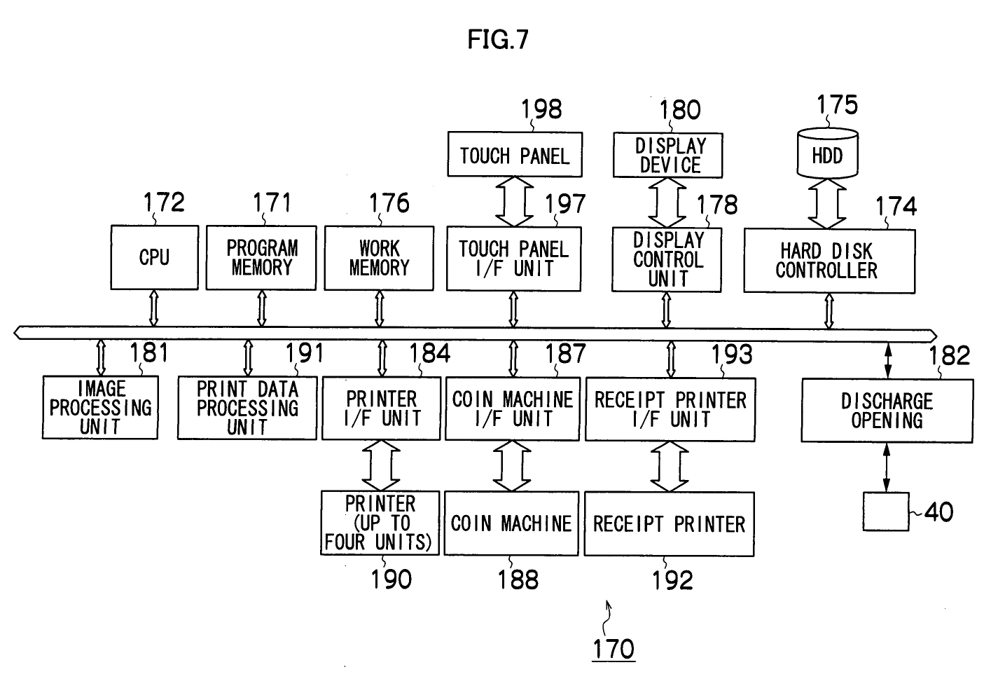

FIG. 7 is a block diagram showing the hardware configuration of the in-store print apparatus 170. When a customer inserts the recording medium 40 taken out from a camera 10 into the media insertion slot 189, a hard disk controller 174 loads control software recorded on a hard disk (HDD) 175 into a program memory 171. If image data is recorded on the recording medium 40 in a state of being compressed in a predetermined format (e.g., an Exif file), a CPU 172 instructs a media reader controller to read out the image data. When the required image data is acquired from the recording medium 40, it is expanded and restored to its original state by an image processing unit 181. The restored image data is further subjected to required image processing in the image processing unit 181 and stored in a work memory 176.

Necessary information such as print size and the number of prints is converted into electrical signals corresponding to positions of the touch panel 198 by a customer's pressing desired positions and input to the CPU 172 through a touch panel interface unit 197. The input information is displayed on the display device 180. The display device 180 is operated by a display control unit 178. The coin machine 188 converts the amount of money displayed on the display device 180 into an electrical signal on the basis of the information input from the touch panel 198 and inputs the signal to the CPU 172 through a coin machine I/F unit 187. The CPU 172 confirms whether the customer has dropped in a required amount of money. When the required amount of money is dropped in, a print data processing unit 191 creates print job data from image data stored in the work memory 176 and sends the print job data to at least one printer 190 through a printer I/F unit 184. The series of controls is performed by the CPU 172.

Each printer 190 adopts a printing technology called TA and uses TA paper which has a characteristic in that it becomes colored upon application of heat and that the color is fixed upon irradiation with light of a predetermined wavelength.

When the printing ends, a receipt on which the amount of the money dropped into the coin machine 188 and the amount of change returned are described is output from a receipt printer 192. The contents to be printed by the receipt printer 192 are prescribed by the CPU 172 through a receipt printer I/F unit 193.

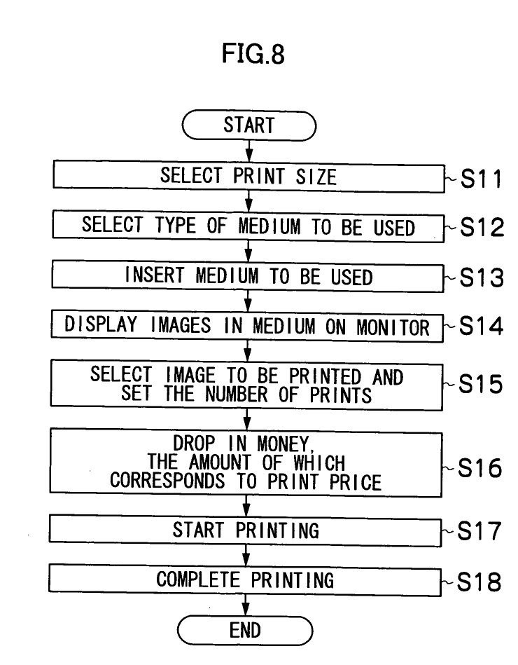

FIG. 8 is a flowchart showing the flow of print order operation in the in-store print apparatus 170.

First, a customer selects a size in which images are to be printed (S11) and selects the type of the recording medium 40 (S12) by pressing displayed portions of a graphical user interface (GUI) displayed on the display device 180. After the selection of these options, the customer inserts the recording medium 40 into the insertion slot 189 (S13). Images read from the recording medium 40 are displayed on the display device 180 (S14).

The customer selects images to be printed and sets the number of prints for each image through the GUI (S15). The CPU 172 calculates a print price from the total number of prints to be made, displays the print price on the display device 180, and waits for money to be dropped in. The customer drops in as much money as required to pay for the print price (S16). When the required amount of money is dropped in, printing starts (S17). When the printing is completed (S18), a printing medium on which images are printed is discharged from the discharge opening 182. The series of operations S11 to S18 is repeated as needed (e.g., when printing of other images follows).

In S14, the images read from the recording medium 40 are displayed on the display device 180. The CPU 172 can classify the images according to folders in which the image files are recorded and display them.

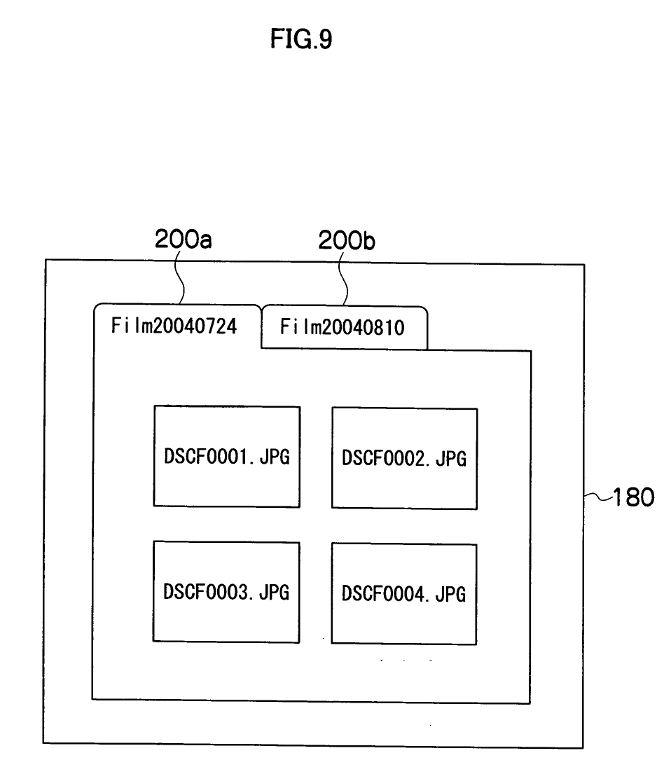

More specifically, the CPU 172 classifies the images according to the folders and displays the images one of the folders at a time. There can be considered various ways of classifying and displaying images. For example, images stored in a folder to which an arbitrarily designated film name is assigned may be displayed in list form. If any of film names “Film20040724” and “Film20040810” is designated by pressing the touch panel 198 at a position where the corresponding one of tabs 200a and 200b on the display device 180 as in FIG. 9 is displayed, the CPU 172 displays, in list form on the display device 180, images stored in a folder to which the designated film name is assigned. In FIG. 9, the file name “Film20040724” is designated, and images “DSCF0001.JPG,” “DSCF0002.JPG,” “DSCF0003.JPG,” and “DSCF0004.JPG” stored in a folder to which the film name “Film20040724” is assigned are displayed in list form.

In the above explanation, in S15, images to be printed are individually selected from the touch panel 198. However, the in-store print apparatus 170 may be configured to allow images to be printed not to be individually selected but to be collectively selected by designating a film name. In S17, all images stored in a folder to which the designated film name is assigned may be printed. If the apparatus is configured to allow an image desired to be printed to be selected among images classified and displayed in the above-described manner, it becomes easy to select an image desired to be printed.

The operation of classifying and displaying images stored in folders to which film names according to the folders is not limited to the in-store print apparatus 170. The operation may be performed by various image display devices such as a personal computer and PDA. A method and program for causing a computing device such as the CPU 172 incorporated in an image display device to perform the operation are, of course, also included in the present invention.

### Third Embodiment

It is possible to manage images in units of virtual “films” even if a folder creation unit 112b creates no folder. More specifically, when a desired film name and the number of images that can be shot, which is a desired number, are input from an operation unit 113 in step S2 of a shooting process, a film management unit 112a records, on a recording medium 40, management data obtained by associating the input film name with the number of images that can be shot for the film (S3). In step S6, a location where recorded images are saved is recorded in the management data after being associated with the film name. The remaining steps (calculation of the number of remaining images and the like) are all performed by the film management unit 112a. With these operations, the correspondence among each film name, the number of images that can be shot for the film, and a location where image data stored in the film is saved is prescribed by the management data, and it can be made to look as if images, the number of which is a number set for each film, are stored in the film.

If an in-store print apparatus 170 reads management data prescribing such a correspondence from the recording medium 40 together with images, to which film each image corresponds can be specified from the management data. Accordingly, it becomes possible to display and print images in units of virtual films without folders.

What is claimed is:

1. An image recording apparatus having an imaging unit which shoots an image of a subject and a recording unit which records the shot image, comprising:
a film management unit which accepts creation of a virtual film which stores the shot image and setting of the number of images storable in the virtual film that can be shot, creates a film management information prescribing a location where an image to be stored in the virtual film is saved and the set number of images that can be shot, and manages the saving location and the set number of the images to be stored in the virtual film according to the film management information.

2. The image recording apparatus according to claim 1, further comprising a display unit which displays the shot image.

3. The image recording apparatus according to claim 2, wherein the display unit displays the shot image stored in the virtual film for each virtual film according to the film management information.

4. The image recording apparatus according to claim 2, wherein the display unit displays the number of remaining images obtained by subtracting the number of images stored in the virtual film from the number of images that can be shot set for the virtual film.

5. The image recording apparatus according to claim 3, wherein the display unit displays the number of remaining images obtained by subtracting the number of images stored in the virtual film from the number of images that can be shot set for the virtual film.

6. The image recording apparatus according to claim 1, wherein the film management unit calculates the number of remaining images obtained by subtracting the number of images stored in the virtual film from the number of images that can be shot set for the virtual film.

7. The image recording apparatus according to claim 4, wherein the film management unit calculates the number of remaining images obtained by subtracting the number of images stored in the virtual film from the number of images that can be shot set for the virtual film.

8. The image recording apparatus according to claim 5, wherein the film management unit calculates the number of remaining images obtained by subtracting the number of images stored in the virtual film from the number of images that can be shot set for the virtual film.

9. The image recording apparatus according to claim 6, wherein the film management unit urges creation of a virtual film and setting of the number of images that can be shot for the virtual film if the number of remaining images reaches 0.

10. The image recording apparatus according to claim 7, wherein the film management unit urges creation of a virtual film and setting of the number of images that can be shot for the virtual film if the number of remaining images reaches 0.

11. The image recording apparatus according to claim 8, wherein the film management unit urges creation of a virtual film and setting of the number of images that can be shot for the virtual film if the number of remaining images reaches 0.

12. The image recording apparatus according to claim 1, further comprising:
a folder creation unit which creates a folder corresponding to the virtual film in the recording unit; and
a folder management unit which stores the shot image equal in number to the set number of images that can be shot in the folder,
wherein a location where the shot image is saved includes a location where the folder corresponding to the virtual film is saved.

13. The image recording apparatus according to claim 10, further comprising:
a folder creation unit which creates a folder corresponding to the virtual film in the recording unit; and
a folder management unit which stores the shot image equal in number to the set number of images that can be shot in the folder,
wherein a location where the shot image is saved includes a location where the folder corresponding to the virtual film is saved.

14. The image recording apparatus according to claim 11, further comprising:
a folder creation unit which creates a folder corresponding to the virtual film in the recording unit; and
a folder management unit which stores the shot image equal in number to the set number of images that can be shot in the folder,
wherein a location where the shot image is saved includes a location where the folder corresponding to the virtual film is saved.

15. An image display apparatus comprising:
a reading unit which reads an image recorded by the image recording apparatus according to claim 1, from the recording unit; and
a display unit which displays, for each virtual film, an image stored in the virtual film, the image read from the recording unit according to the film management information.

16. An image display apparatus comprising:
a reading unit which reads an image recorded by the image recording apparatus according to claim 13, from the recording unit; and
a display unit which displays, for each virtual film, an image stored in the virtual film, the image read from the recording unit according to the film management information.

17. An image display apparatus comprising:
a reading unit which reads an image recorded by the image recording apparatus according to claim 14, from the recording unit; and
a display unit which displays, for each virtual film, an image stored in the virtual film, the image read from the recording unit according to the film management information.

18. A print apparatus comprising:
a reading unit which reads an image recorded by the image recording apparatus according to claim 1, from the recording unit;
a designation unit which designates a virtual film in which an image to be printed is stored for the image read from the recording unit according to the film management information; and
a print unit which prints the image stored in the designated virtual film according to the film management information.

19. A print apparatus comprising:
a reading unit which reads an image recorded by the image recording apparatus according to claim 13, from the recording unit;
a designation unit which designates a virtual film in which an image to be printed is stored for the image read from the recording unit according to the film management information; and
a print unit which prints the image stored in the designated virtual film according to the film management information.

20. A print apparatus comprising:
a reading unit which reads an image recorded by the image recording apparatus according to claim 14, from the recording unit;
a designation unit which designates a virtual film in which an image to be printed is stored for the image read from the recording unit according to the film management information; and
a print unit which prints the image stored in the designated virtual film according to the film management information.

21. An image recording method performed by an image recording apparatus having an imaging unit which shoots an image of a subject and a recording unit which records the shot image, the image recording method comprising:
a step of accepting creation of a virtual film which stores the shot image and setting of the number of images that can be shot for the virtual film, a step of creating a film management information prescribing a location where an image to be stored in the virtual film is saved and the set number of images that can be shot, and
a step of managing the saving location and the set number of the images to be stored in the virtual film according to the film management information.

22. An image display method, comprising:
a step of reading an image recorded by the image recording method according to claim 21, from the recording unit; and
a step of displaying, for each virtual film, an image stored in the virtual film, the image read from the recording unit according to the film management information.

23. A print method, comprising:
a step of reading an image recorded by the image recording method according to claim 21, from the recording unit;
a step of designating a virtual film in which an image to be printed is stored for the image read from the recording unit according to the film management information; and
a step of printing the image stored in the designated virtual film according to the film management information.

24. An image recording program performed by an image recording apparatus having an imaging unit which shoots an image of a subject, a recording unit which records the image, and a computing unit, and causes the computing unit to perform the steps of:
accepting creation of a virtual film which stores the shot image and setting of the number of images that can be shot for the virtual film;
creating a film management information prescribing a location where an image to be stored in the virtual film is saved and the set number of images that can be shot; and
managing the saving location and the set number of images to be stored in the virtual film is saved according to the film management information.
